(19) United States
(12) Patent Application Publication
(10) Pub. No.: US 2018/0241313 A1
(43) Pub. Date: Aug. 23, 2018

(54) DCDC CONVERTER INTEGRATED CHARGER

(71) Applicant: HITACHI AUTOMOTIVE SYSTEMS, LTD., Ibaraki (JP)

(72) Inventors: Akihiro GOTO, Hitachinaka (JP); Yoshiharu YAMASHITA, Hitachinaka (JP); Hiroyuki SHOJI, Hitachinaka (JP)

(73) Assignee: HITACHI AUTOMOTIVE SYSTEMS, LTD., Ibaraki (JP)

(21) Appl. No.: 15/750,461

(22) PCT Filed: Jul. 20, 2016
(86) PCT No.: PCT/JP2016/071201

§ 371 Date: Feb. 5, 2018

(30) Foreign Application Priority Data
Aug. 6, 2015 (JP) 2015-155623

(51) Int. Cl. H02M 3/18; H02M 3/335; H02J 7/34; B60R 16/04

(52) U.S. Cl. CPC H02M 3/18; H02M 3/33592; H02M 2001/0003; B60R 16/04; H02J 7/34

(57) ABSTRACT

Provided is a DCDC converter integrated charger having a small occupation area of a storage space and capable of suppressing noise interference. Included are a first wall separating a first space, where a switching circuit section is disposed, and a second space where an input filter circuit section and an output filter circuit section are disposed, and a second wall separating a third space which faces the first wall through a second space and where a DCDC converter circuit section is disposed and the second space.

### TECHNICAL FIELD

The present invention relates to a DCDC converter integrated charger.

### BACKGROUND ART

Various electric power conversion devices, such as an inverter for driving a motor, a charger for charging a high voltage battery from a commercial power source and a DCDC converter for supplying power to an auxiliary battery, are mounted on vehicles such as electric automobiles and hybrid automobiles. In the charger and the electric power conversion device, a switching circuit, which generates large radio frequency noise is, used. In recent years, countermeasures against noise interference have become important due to speed-up of switching circuits, miniaturization of various electric power conversion devices, and cost reduction.

As an in-vehicle electric power conversion device which suppresses the noise interference, there has been known a structure in which a partition wall is provided at a middle section of a metal housing, and a filter circuit section and a main power system circuit section are divided by the partition wall and disposed in the housing, and a GND plane which covers both the circuit sections is disposed on the upper side. It is described that, in this device, the noise interference between circuit sections is suppressed by separating and shielding, through the partition wall and the GND plane, the filter circuit section and the main power system circuit section planarly disposed (e.g., see PTL 1).

### CITATION LIST

### Patent Literature

PTL 1: International Publication WO2014/033852

### SUMMARY OF INVENTION

### Technical Problem

The in-vehicle electric power conversion device described in PTL 1 has a structure in which a filter circuit section and a main power system circuit section, which are planarly disposed, are separated by a partition wall, and a GND plane which covers both circuit sections is disposed on the upper side. Thus, the area in plan view becomes large, and a large storage space is needed. Moreover, no structure of a DCDC converter integrated charger for suppressing noise interference is described in PTL 1.

### Solution to Problems

A DCDC converter integrated charger of the present invention includes: an input filter circuit section which removes input noise; a switching circuit section which converts AC power or first DC power inputted to the input filter circuit section into second DC power; an output filter circuit section which is connected to the switching circuit section and removes output noise; a DCDC converter circuit section which is connected to the switching circuit section and supplies power to a battery; a first wall which separates a first space, where the switching circuit section is disposed, and a second space, where the input filter circuit section and the output filter circuit section are disposed; and a second wall which separates a third space, which faces the first wall through the second space and where the DCDC converter circuit section is disposed, and the second space.

### Advantageous Effects of Invention

According to the present invention, a DCDC converter integrated charger, which is capable of reducing an area in a plan view and suppressing noise interference with input/output filter circuit sections, is provided.

### BRIEF DESCRIPTION OF DRAWINGS

FIG. 1 is a circuit diagram as Embodiment 1 of a DCDC converter integrated charger of the present invention.

FIG. 2(A) is a perspective view of Embodiment 1 of the DCDC converter integrated charger of the present invention, and FIG. 2(B) is a cross-sectional view along the line IIB-IIB in FIG. 2(A).

FIG. 3 is an external perspective view of Embodiment 2 of the DCDC converter integrated charger of the present invention.

FIG. 4 is a cross-sectional view along the line IV-IV in FIG. 3.

FIG. 5 is an exploded perspective view of the DCDC converter integrated charger shown in FIG. 3.

FIG. 6(A) is an external perspective view of Embodiment 3 of the DCDC converter integrated charger of the present invention, and FIG. 6(B) is a cross-sectional view along the line VIB-VIB in FIG. 6(A).

FIG. 7(A) is an external perspective view of Embodiment 4 of the DCDC converter integrated charger of the present invention, and FIG. 7(B) is a cross-sectional view along the line VIIB-VIIB in FIG. 7(A).

FIG. 8(A) is a perspective view of Embodiment 5 of the DCDC converter integrated charger of the present invention, and FIG. 8(B) is a cross-sectional view along the line VIIIB-VIIIB in FIG. 8(A).

FIG. 9(A) is a perspective view of Embodiment 6 of the DCDC converter integrated charger of the present invention, and FIG. 9(B) is a plan view from the top in FIG. 9(A).

FIGS. 10(A) and 10(B) show Embodiment 7 of the DCDC converter integrated charger of the present invention, in which FIG. 10(A) is a perspective view showing a cooling passage through a housing, and FIG. 10(B) is a cross-sectional view along the line XB-XB in FIG. 10(A).

### DESCRIPTION OF EMBODIMENTS

### Embodiment 1

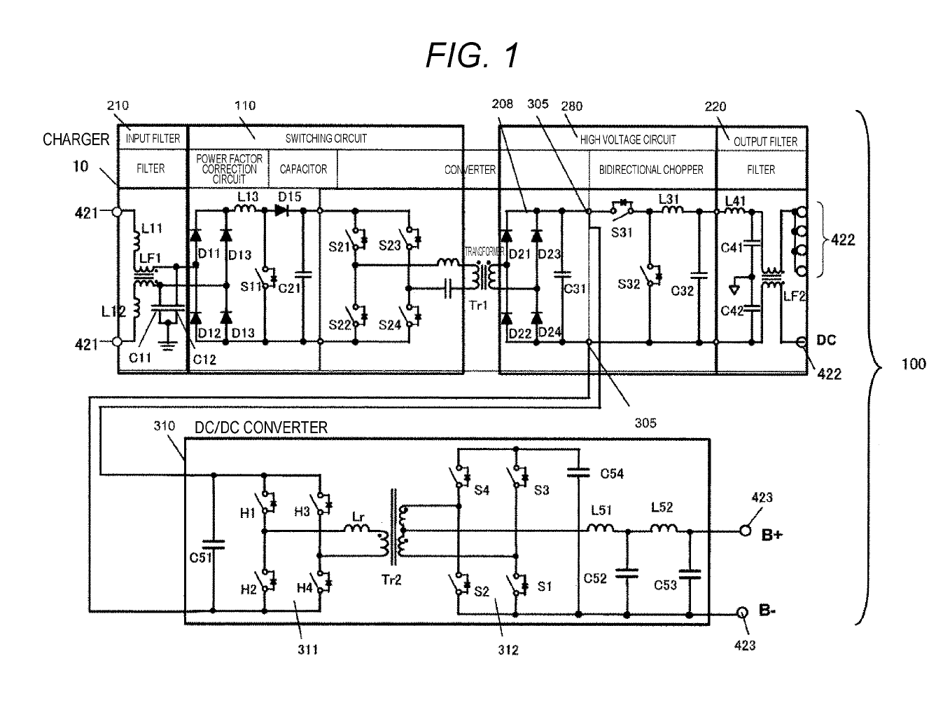

Hereinafter, Embodiment 1 of a DCDC converter integrated charger of the present invention will be described with reference to FIGS. 1 to 3.

FIG. 1 is a circuit diagram of the DCDC converter integrated charger of the present invention. A DCDC converter integrated charger 100 is used for vehicles such as hybrid automobiles, electric automobiles and the like. A vehicle including a motor includes a high voltage battery and an auxiliary battery with a voltage lower than that of the high voltage battery (not shown), in addition to the DCDC converter integrated charger 100. The DCDC converter integrated charger 100 has a charger 10 and a DCDC converter circuit section 310. The charger 10 is capable of charging the high voltage battery by connecting an external power source to the high voltage battery. That is, an external AC or DC power source is connected to input terminals 421 of the charger 10. Furthermore, output terminals 422 of the charger 10 are connected to the high voltage battery. The DCDC converter circuit section 310 is connected to the charger 10. The DCDC converter circuit section 310 converts high voltage DC power into low voltage DC power to supply the power to the auxiliary battery.

The charger 10 has an input filter circuit section 210, a switching circuit section 110, a high voltage circuit section 280 and an output filter circuit section 220. The DCDC converter circuit section 310 is connected to the charger 10 at connection sections 305 of the high voltage circuit section 280. The input filter circuit section 210 includes a common mode filter LF1, inductors L11 and L12 and line bypass capacitors C11 and C12. The inductors L11 and L12 are connected to the external power source through the input terminals 421. The line bypass capacitors C11 and 12 bypass noise components to a GND.

The switching circuit section 110 has a power factor correction circuit (hereinafter, referred to as a PFC circuit), a capacitor C21 and a full bridge circuit. The common mode filter LF1 is connected to a rectifier circuit formed by four diodes D11 to D14. The rectifier circuit has a function of converting an AC voltage into a DC voltage. An output side of the rectifier circuit is connected to an input side of the power factor correction (PFC) circuit. The PFC circuit includes an inductor L13, a switching element S11, a diode D15 and the capacitor C21. Power factor correction operation is performed by turning on/off the switching element S11. As the switching element S11, for example, an NMOSFET can be used.

An output side of the PFC circuit is connected to an input side of the full bridge circuit. The full bridge circuit includes a series connection body of a first switching element S21 and a second switching element S22 and a series connection body of a third switching element S23 and a fourth switching element S24. A connection point between the first switching element S21 and the second switching element S22 is connected to a connection point between the third switching element S23 and the fourth switching element S24 through a primary side coil of a transformer Tr1. As the first to fourth switching elements S21 to S24, for example, NMOSFETs can be used.

The high voltage circuit section 280 includes a rectifier circuit and a bidirectional chopper. The rectifier circuit has four diodes D21 to D24. The rectifier circuit has a function of converting an AC voltage of the secondary side coil of the transformer Tr1 into a DC voltage. That is, the first to fourth switching elements S21 to S24 of the switching circuit section 110, the diodes D21 to D24 of the high voltage circuit section 280, and the transformer Tr1 function as converters. The current flowing through the rectifier circuit charges a capacitor C31 for current-voltage conversion.

The bidirectional chopper includes an inductor L31, a capacitor C32, a switching element S31 which is disposed between the inductor L31 and the capacitor C31, and a switching element S32 in which one end is connected between the inductor L31 and the switching element S31 and the other end is connected to the GND side. By adjusting on/off timings of the switching elements S31 and S32, an output voltage is made constant with respect to a load voltage.

The output filter circuit section 220 includes a common mode filter LF2, an inductor L41 and line bypass capacitors C41 and C42. One end of the inductor L41 is connected to the inductor L31 and the capacitor C32 of the bidirectional chopper, and the other end is connected to the capacitor C41 and the common mode filter LF2. The common mode filter LF2 is connected to the high voltage battery through the output terminals 422.

The DCDC converter circuit section 310 includes a high voltage circuit section 311 which converts a high DC voltage into a high AC voltage, a transformer Tr2 which converts the high AC voltage into a low AC voltage, and a low voltage circuit section 312 which converts the low AC voltage into a DC voltage.

The high voltage circuit section 311 includes four MOSFETs H1 to H4 connected as an H bridge type. The high voltage circuit section 311 also includes a smoothing capacitor C51. An AC voltage is generated on the primary side of the transformer Tr2 by performing phase shift PWM control on the four MOSFETs H1 to H4 of the high voltage circuit section 311. A resonance choke coil Lr is connected between the high voltage circuit section 311 and the transformer Tr2. By using the combined inductor of the inductor of the resonance choke coil Lr and the leakage inductor of the transformer Tr2, zero voltage switching of the MOSFETs H1 to H4 constituting the high voltage circuit section 311 can be performed.

The low voltage circuit section 312 has two rectification phases constituted by MOSFETs S1 and S2 and a smoothing circuit constituted by a smoothing inductor L51 and a smoothing capacitor C52. High potential sides of the respective rectification phases, that is, wires at the drain sides of the MOSFET S1 and S2 are connected to the secondary side of the transformer Tr2. The secondary side center tap terminal of the transformer Tr2 is connected to the smoothing inductor L51, and the smoothing capacitor C52 is connected to an output side of the smoothing inductor L51.

The low voltage circuit section 312 includes an active clamp circuit for suppressing a surge voltage applied to the MOSFETs S1 and S2. The active clamp circuit includes active clamping MOSFETs S3 and S4 and an active clamping capacitor C54. A filter inductor L52 and a filter capacitor C53 are provided at the output side of the low voltage circuit section 312 to remove noise superimposed on an output voltage. The high voltage circuit section 311, the low voltage circuit section 312 and the active clamp circuit are controlled by a control circuit (not shown).

The DCDC converter circuit section 310 is connected to the auxiliary battery through auxiliary output terminals 423.

The DCDC converter integrated charger 100 includes the switching circuit section 110 having the switching elements S11 and S21 to S24 and the DCDC converter circuit section 310 having the switching elements H1 to H4 and S1 to S4. Thus, there is a possibility that noise generated from the switching circuit section 110 and the DCDC converter circuit section 310 interferes with the input filter circuit section 210 and the output filter circuit section 220. Hereinafter, Embodiment 1 of the DCDC converter integrated charger 100 capable of suppressing noise interference with the input/output filter circuit sections 210 and 220 will be described. Note that, although the switching elements S31 and S32 are provided in the high voltage circuit section 280, the switching elements S31 and S32 have low operating frequencies and thus hardly causes noise interference with the input/output filter circuit sections 210 and 220.

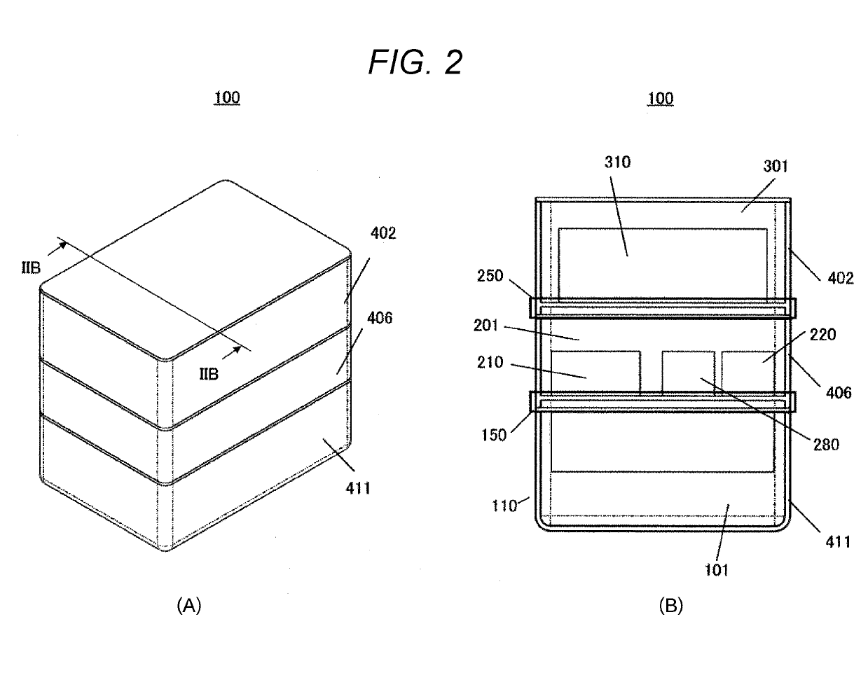

FIG. 2(A) is a perspective view of Embodiment 1 of the DCDC converter integrated charger of the present invention, and FIG. 2(B) is a cross-sectional view along the line IIB-IIB in FIG. 2(A). The DCDC converter integrated charger 100 has a first space housing 411, a second space housing 406 and a third space housing 402. The first to third space housings 411, 406 and 402 are formed of a conductive member such as an aluminum alloy and are stacked in three stages as shown in the drawing. The first space housing 411 at the lowermost stage has a first space 101 therein, the second space housing 406 at the middle stage has a second space 201 therein, and the third space housing 402 at the uppermost stage has a third space 301 therein.

A first wall 150 is provided at the boundary between the first space housing 411 at the lowermost stage and the second space housing 406 at the middle stage. The first wall 150 is a placoid member formed of a conductive member and separates the first space 101 and the second space 201. In other words, the first space 101 and the second space 201 are shielded by the first wall 150. A second wall 250 is provided at the boundary between the second space housing 406 at the middle stage and the third space housing 402 at the uppermost stage. The second wall 250 is a placoid member formed of a conductive member and separates the second space 201 and the third space 301. In other words, the second space 201 and the third space 301 are shielded by the second wall 250. Note that, although it is described that the first wall 150 and the second wall 250 separate the spaces, the first wall 150 and the second wall 250 include connection member insertion sections through which the connection members necessary for circuit connection are inserted.

The input filter circuit section 210, the output filter circuit section 220 and the high voltage circuit section 280 are disposed in the second space 201. The input filter circuit section 210, the output filter circuit section 220 and the high voltage circuit section 280 are disposed, for example, on the upper surface of the first wall 150. The switching circuit section 110 is disposed in the first space 101. The switching circuit section 110 is fixed, for example, to the lower surface of the first wall 150. Although not shown, the switching circuit section 110 is connected to the input filter circuit section 210 and the high voltage circuit section 280 by a connection member inserted through a connection member insertion section provided in the first wall 150.

The DCDC converter circuit section 310 is disposed in the third space 301. The DCDC converter circuit section 310 is disposed, for example, on the upper surface of the second wall 250. Although not shown, the DCDC converter circuit section 310 is connected to the high voltage circuit section 280 by a connection member inserted through a connection member insertion section provided in the second wall 250.

According to the DCDC converter integrated charger 100 of Embodiment 1 described above, the following effects are exerted.

(1) The input filter circuit section 210 and the output filter circuit section 220 were disposed in the second space 201, the switching circuit section 110 was disposed in the first space 101, and the DCDC converter circuit section 310 was disposed in the third space 301. Then, the second space housing 406 having the second space 201, the first space housing 411 having the first space 101, and the third space housing 402 having the third space 301 were stacked. Moreover, the second space 201 and the first space 101 were separated by the first wall 150, and the second space 201 and the third space 301 were separated by the second wall 250. Therefore, the area in a plan view becomes small, and the area of the storage space can be reduced. Furthermore, it is possible to suppress the noise generated in the switching circuit section 110 and the DCDC converter circuit section 310 from interfering with the input filter circuit section 210 and the output filter circuit section 220 and adversely affecting the circuits.

(2) In the configuration of the above (1), the high voltage circuit section 280 was disposed in the second space 201. Since the switching elements S31 and S32 of the high voltage circuit section 280 have small operating frequencies, the switching elements S31 and S32 hardly cause noise interference even if they are disposed in the same space as the input/output filter circuit sections 210 and 220.

The DCDC converter integrated charger 100 can adopt various embodiments as described below. Note that the DCDC converter integrated charger 100 has the circuit configuration shown in FIG. 1 in the following embodiments as well.

### Embodiment 2

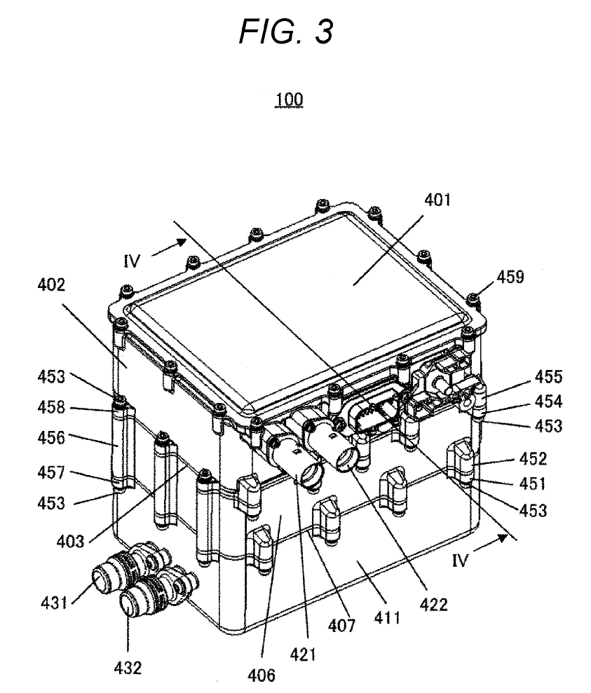

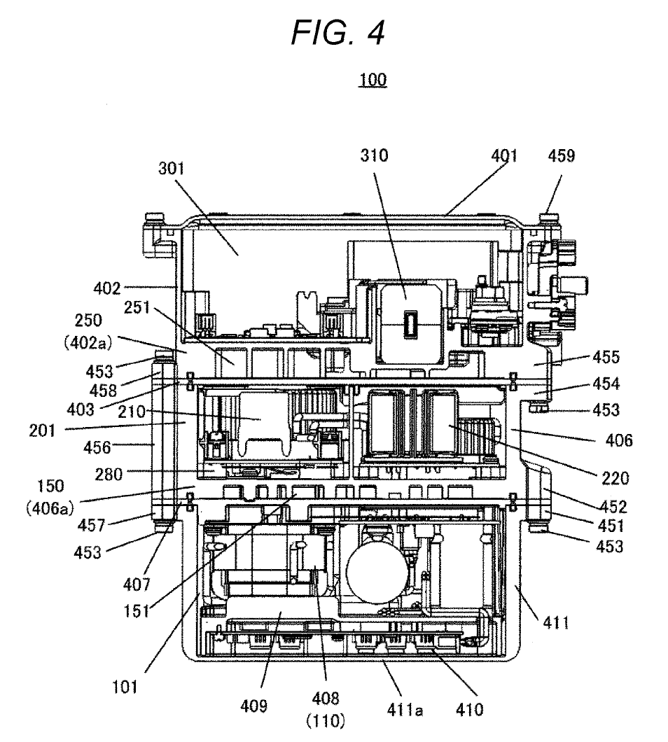

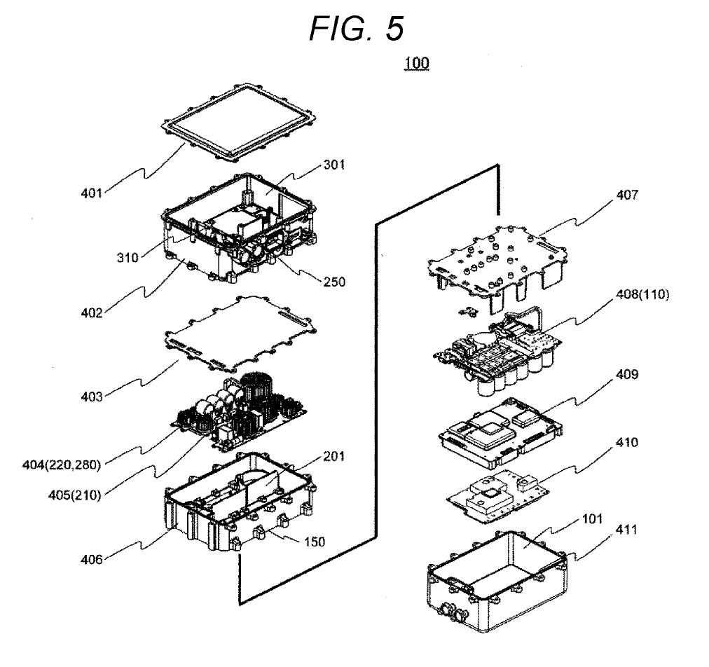

FIG. 3 is an external perspective view of Embodiment 2 of the DCDC converter integrated charger of the present invention. FIG. 4 is a cross-sectional view along the line IV-IV in FIG. 3. FIG. 5 is an exploded perspective view of the DCDC converter integrated charger shown in FIG. 3. A DCDC converter integrated charger 100 has a first space housing 411, a second space housing 406 and a third space housing 402. The first to third housings 411, 406 and 402 are formed of a conductive member such as an aluminum alloy and are stacked in three stages as shown in the drawing. As shown in FIGS. 4 and 5. The first space housing 411 at the lowermost stage has a first space 101 therein, the second space housing 406 at the middle stage has a second space 201 therein, and the third space housing 402 at the uppermost stage has a third space 301 therein.

As shown in FIG. 3, an input terminal 421 and an output terminal 422 are provided at one side of the third space housing 402. The input terminal 421 is connected to an input filter circuit section 210. An output filter circuit section 220 is connected to the output terminal 422. As will be described later, the input filter circuit section 210 and the output filter circuit section 220 are stored in the second space housing 406. The input terminal 421 and the output terminal 422 are provided so as to extend close to and in the vicinity of the corner section of the one side of the third space housing 402 in parallel.

At one side of the first space housing 411, an inlet port 431 into which a coolant such as cooling water is introduced, and an outlet port 432 through which the coolant is led out are provided. As shown in FIG. 4, a second passage 251 is provided at a bottom section 402a of the third space housing 402, and a first passage 151 is provided at a bottom section 406a of the second space housing 406. The inlet port 431, the second passage 251, the first passage 151, and the outlet port 432 communicate with each other, and the coolant introduced from the inlet port 431 flows through the third space housing 402 and the second space housing 406 in order of the second passage 251, the first passage 151 and the outlet port 432 and is led out from the outlet port 432. Accordingly, the entire DCDC converter integrated charger 100 is cooled down.

The upper surface of the third space housing 402 is hermetically sealed by an upper cover 401. The upper cover 401 is made of a metal such as iron or an aluminum alloy. The upper cover 401 is fixed to the third space housing 402 by fastening members 459 such as bolts. The bottom section 402a of the third space housing 402 has the function of a second wall 250. That is, the third space 301 and the second space 201 are separated from each other. The bottom section 406a of the second space housing 406 has the function of a first wall 150. That is, the second space 201 and the first space 101 are separated from each other.

A DCDC converter circuit section 310 is disposed in the third space 301 of the third space housing 402. An HV board 404 and a filter board 405 are stored in the second space 201 of the second space housing 406. A high voltage circuit section 280 and an output filter circuit section 220 are mounted on the HV board 404. An input filter circuit section 210 is mounted on the filter board 405. An upper cooling cover 403 is disposed between the bottom section 406a of the second space housing 406 and the third space housing 402. The upper cooling cover 403 closes the opening surface of the second passage 251.

A control board 410, a chassis 409 and a PFC board 408 are stored in the first space 101 of the first space housing 411. A switching circuit section 110 is mounted on the PFC board 408. A control circuit section, which controls the driving of a charger 10 and the DCDC converter circuit section 310, is mounted on the control board 410. To shield the control board 410, the chassis 409 is fixed to a bottom section 411a of the first space housing 411, surrounding the control board 410. A lower cooling cover 407 is disposed between the first space housing 411 and the bottom section 406a of the second space housing 406. The lower cooling cover 407 closes the opening surface of the first passage 151.

As shown in FIGS. 3 and 4, the first space housing 411 and the second space housing 406 are provided with flange sections 451 and 452 provided with female screw sections at one side, respectively. The second space housing 406 and the third space housing 402 are provided with flange sections 454 and 455 provided with female screw sections at one side, respectively. Moreover, boss sections 456, which have lengths extending over the entire height of the second space housing 406 and are provided with female screw sections in the axial direction, are formed on other side of the second space housing 406. Corresponding to the boss sections 456, flange sections 457 and 458 provided with female screw sections are formed at the first space housing 411 and the third space housing 402, respectively.

The lower cooling cover 407 is interposed between the first space housing 411 and the bottom section 406a of the second space housing 406, the flange sections 451 and the flange sections 452 are fixed by fastening members 453 such as bolts, and the flange sections 457 and the boss sections 456 are also fixed. Moreover, the upper cooling cover 403 is interposed between the second space housing 406 and the bottom section 402a of the third space housing 402, the flange sections 454 and the flange sections 455 are fixed by the fastening members 453 such as bolts, and the flange sections 458 and the boss sections 456 are also fixed. Thus, the first to third space housings 411, 406 and 402 are integrated, and the DCDC converter integrated charger 100, in which the first and second passages 151 and 251 are hermetically sealed by the upper and lower cooling covers 403 and 407, is obtained.

In Embodiment 2, the input filter circuit section 210 and the output filter circuit section 220 disposed in the second space 201 are separated, by the first wall 150, from the switching circuit section 110 disposed in the first space 101. Moreover, the input filter circuit section 210 and the output filter circuit section 220 are separated, by the second wall, from the DCDC converter circuit section 310 disposed in the third space 301. Furthermore, the high voltage circuit section 280 is disposed in the second space 201. Therefore, also in Embodiment 2, effects similar to the effects (1) and (2) of Embodiment 1 are exerted. In addition, in Embodiment 2, it is possible to provide the DCDC converter integrated charger 100 which can be applied to a case where cooling by a coolant such as cooling water is required.

### Embodiment 3

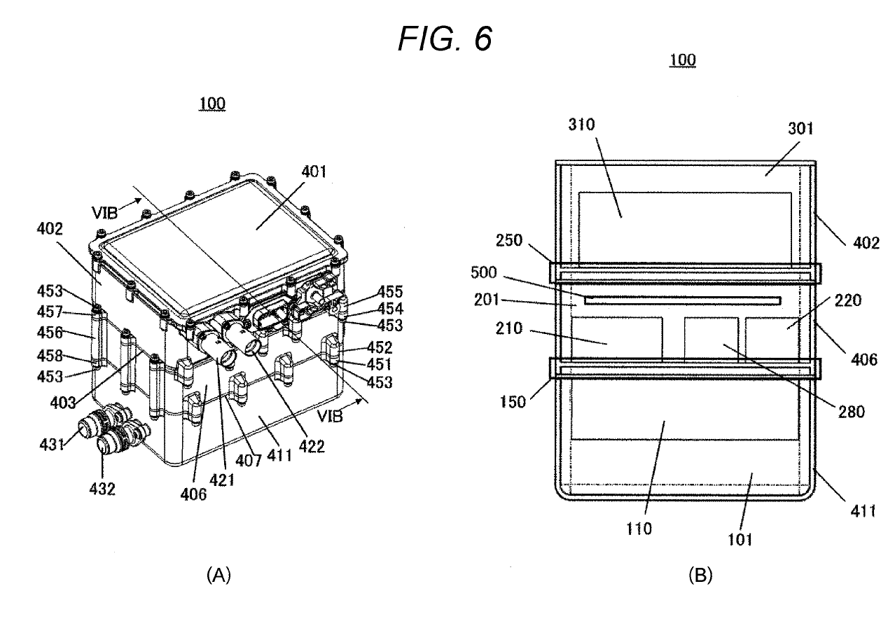

FIG. 6(A) is an external perspective view of Embodiment 3 of the DCDC converter integrated charger of the present invention, and FIG. 6(B) is a cross-sectional view along the line VIB-VIB in FIG. 6(A).

The appearance of Embodiment 3 is similar to that in FIG. 3 shown as Embodiment 2. The difference between Embodiment 3 and Embodiment 2 is that Embodiment 3 has a configuration in which a control circuit section 500 having the same function as a control circuit section 410 (see FIG. 4) stored in the first space 101 in Embodiment 2 is disposed in the second space 201 of the second space housing 406. The second space 201 is separated from the switching circuit section 110 and the DCDC converter circuit section 310 by the first wall 150 and the second wall 250. Therefore, it is possible to suppress the influence of noise generated in the switching circuit section 110 and the DCDC converter circuit section 310 on the input/output circuit sections 210 and 220.

Other configurations of Embodiment 3 are similar to those of Embodiments 1 and 2 so that the same reference signs are given to the corresponding members and the descriptions thereof are omitted. Also in Embodiment 3, effects similar to the effects (1) and (2) of Embodiment 1 are exerted. Moreover, in Embodiment 3, a point that the control circuit section 500 can be shielded against noise interference is the same as Embodiment 2. However, in Embodiment 3, since the control circuit section 500 is disposed in the second space 201 shielded by the first wall 150 and the second wall 250, the chassis 409 in Embodiment 2 can be unnecessary. This simplifies the structure and makes it inexpensive.

### Embodiment 4

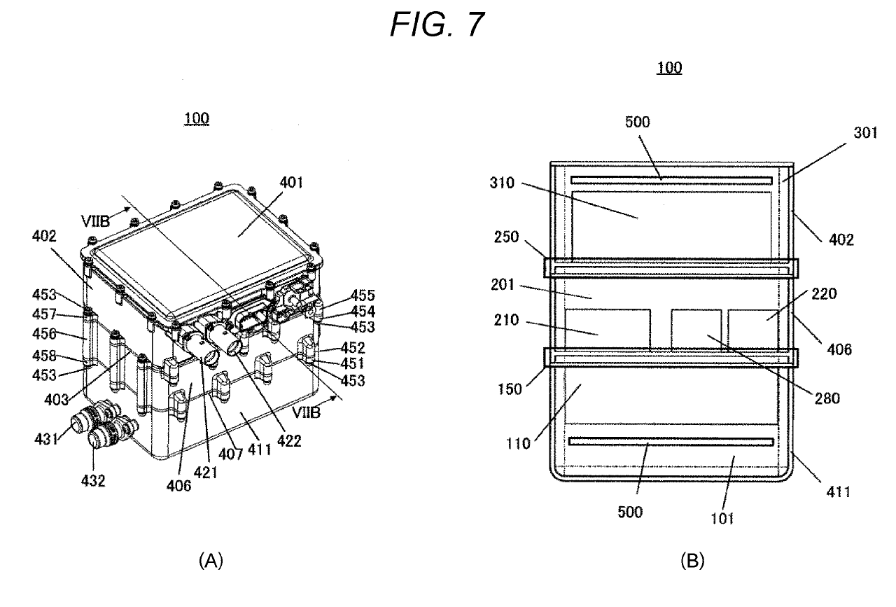

FIG. 7(A) is an external perspective view of Embodiment 4 of the DCDC converter integrated charger of the present invention, and FIG. 7(B) is a cross-sectional view along the line VIIB-VIIB in FIG. 7(A). The difference of the DCDC converter integrated charger 100 between Embodiment 4 and Embodiment 3 is that Embodiment 4 has a configuration in which the control circuit section 500 stored in the second space 201 is divided into two and one is disposed in the first space 101 of the first space housing 411 and the other is disposed in the third space 301 of the third space housing 402. Other configurations of Embodiment 4 are similar to those of Embodiment 3. Therefore, also in Embodiment 4, effects similar to those of Embodiment 2 are exerted. Note that, in Embodiment 4, the control circuit section 500 may be shielded by using a chassis to protect the control circuit section 500 from other circuits which generate noise. Moreover, the control circuit section 500 may be disposed in the second space 201 and in other space, the first space 101 or the third space 301 by combining Embodiment 3 and Embodiment 4. Furthermore, the control circuit section 500 may be disposed in all of the first to third spaces 101, 201 and 301.

### Embodiment 5

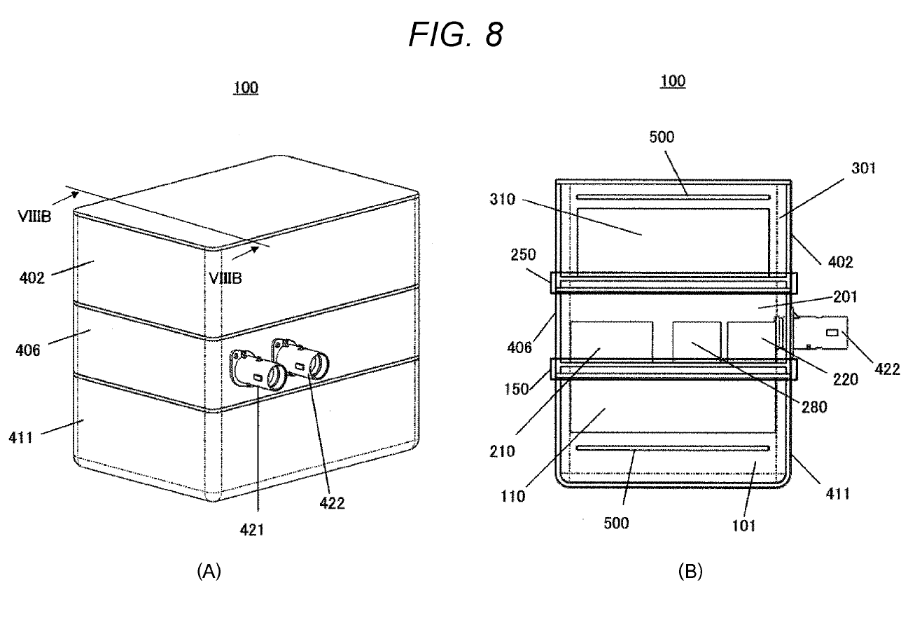

FIG. 8(A) is a perspective view of Embodiment 5 of the DCDC converter integrated charger of the present invention, and FIG. 8(B) is a cross-sectional view along the line VIIIB-VIIIB in FIG. 8(A). The difference between Embodiment 5 and Embodiment 4 is that Embodiment 5 has a configuration in which the input terminal 421 and the output terminal 422 are attached to the second space housing 406. As previously mentioned, the input terminal 421 is connected to the input filter circuit section 210. AC power or DC power is supplied to the input terminal 421. The output terminal 422 is connected to the output filter circuit section 220. The output terminal 422 is an output terminal for supplying power to the high voltage battery. Other configurations of Embodiment 5 are similar to those of Embodiment 4. Therefore, also in Embodiment 5, effects similar to those of Embodiment 4 are exerted. Note that the input terminal 421 and the output terminal 422 may be disposed in the first space housing 411.

### Embodiment 6

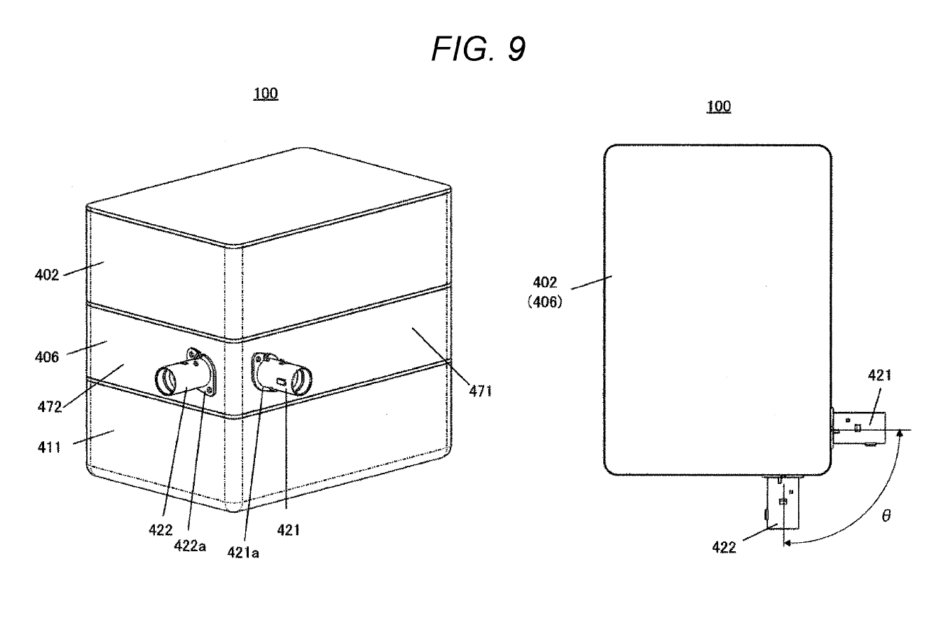

FIG. 9(A) is a perspective view of Embodiment 6 of the DCDC converter integrated charger of the present invention, and FIG. 9(B) is a plan view from the top in FIG. 9(A). The difference between Embodiment 6 and Embodiment 5 is that Embodiment 6 has a configuration in which the input terminal 421 and the output terminal 422 are attached to different sides of the second space housing 406. An attachment section 421a of the input terminal 421 is fixed to a first side 471 of the second space housing 406. An attachment section 422a of the output terminal 422 is fixed to a second side 472 adjacent to the first side 471. Therefore, as shown in FIG. 9(B), the input terminal 421 and the output terminal 422 are oriented in different directions by an angle θ of 90 degrees in the axial directions thereof. In other words, the input terminal attachment surface which is the first side 471 where the input terminal 421 is disposed and the output terminal attachment surface which is the first side 471 where the output terminal 422 is disposed are different by 90 degrees.

Other configurations of Embodiment 6 are similar to those of Embodiment 5. Therefore, Embodiment 6 exerts effects similar to those of Embodiment 5. Moreover, by disposing the input terminal 421 and the output terminal 422 at different sides as in Embodiment 6, it is possible to freely adapt to attachment angles of the connection terminals of external electric apparatuses and changes in the layout. That is, by disposing the input terminal 421 and the output terminal 422 at the adjacent surfaces or the opposing surfaces so as to direct the angle θ in the axial direction to different directions, such as 90 degrees, 180 degrees, or 270 degrees, it is possible shorten the connection members to external electric apparatuses and simplify the routing. Thus, the degree of freedom with respect to changes in the layout can be increased. Note that the angle θ in the axial direction between the input terminal 421 and the output terminal 422, in other words, the angle θ between the force terminal attachment surface and the output terminal attachment surface can be set to an angle other than 90 degrees, 180 degrees and 270 degrees by changing the shapes of the housings from rectangular to other polygonal shapes.

Note that the input terminal 421 and the output terminal 422 may be disposed in the first space housing 411 or the third space housing 402. Moreover, the input terminal 421 and the output terminal 422 may be disposed in different housings. Furthermore, the input terminal 421 and the output terminal 422 may be disposed, for example, at positions which are mutually distant, such as positions on a diagonal line, instead of the positions which are close. When the distance between the input terminal 421 and the input filter circuit section 210 or the distance between the output terminal 422 and the output filter circuit section 220 are long, noise interference increases. By setting the attachment sides, attachment positions, the angle in the axial direction of the housings so as to shorten the distance between the input terminal 421 and the input filter circuit section 210 and the distance between the output terminal 422 and the output filter circuit section 220, it is possible to reduce the noise interference further.

### Embodiment 7

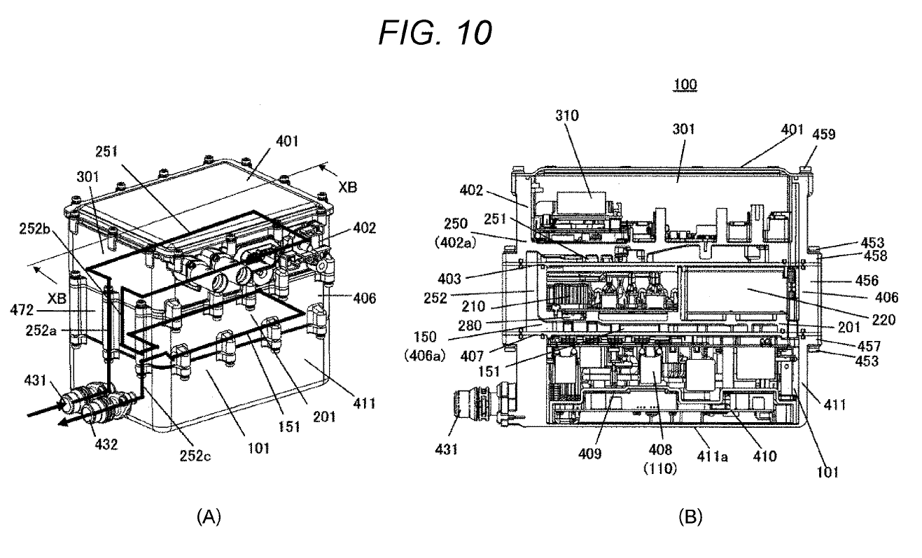

FIGS. 10(A) and 10(B) show Embodiment 7 of the DCDC converter integrated charger of the present invention, in which FIG. 10(A) is a perspective view showing a cooling passage through a housing, and FIG. 10(B) is a cross-sectional view along the line XB-XB in FIG. 10(A). FIGS. 10(A) and 10(B) shown as Embodiment 7 show the cooling structure of Embodiment 2 in more detail. Since the structure relating to the suppression of noise interference in Embodiment 7 is similar to that of Embodiment 2, the same reference signs are given to the corresponding members and the descriptions thereof are omitted. The cooling structure will be described hereinafter.

As described in Embodiment 2, the inlet port 431 into which a coolant is introduced and the outlet port 432 through which the coolant is led out are provided at one side of the first space housing 411. The second passage 251 is provided at the bottom section 402a of the third space housing 402, that is, the second wall 250, and the first passage 151 is provided at the bottom section 406a of the second space housing 406, that is, the first wall 150.

As shown in FIG. 10(A), the second passage 251 is substantially annularly provided along the peripheral section of the bottom section 402a of the third space housing 402, and the first passage 151 is substantially annularly provided along the peripheral section of the bottom section 406a of the second space housing 406.

In the second space housing 406 and the first space housing 411, a first relay passage 252a, which communicates the inlet port 431 and the starting terminal of the second passage 251, is formed. In the second space housing 406, a second relay passage 252b, which communicates the end terminal of the second passage 251 and the starting terminal of the first passage 151, is formed. In the first space housing 411, a third relay passage 252c, which communicates the end terminal of the first passage and the outlet port 432, is formed. The first to third relay passages 252a to 252c are extend substantially vertically with respect to the first wall 150 and the second wall 250 and formed at a side of the first space housing 411 and the side 472 of the second space housing 406, where the inlet port 431 and the outlet port 432 are provided.

The coolant introduced from the inlet port 431 flows in order of the first relay passage 252a, the second passage 251, the second relay passage 252b, the first passage 151 and the third relay passage 252c and is led out from the outlet port 432. This cools down the heat generated in the DCDC converter circuit section 310 and the charger 10.

Also in Embodiment 7, effects similar to those of Embodiment 2 are exerted. In particular, as for the cooling effects, the following effects are exerted.

(1) Although the first to third space housings 411, 406 and 402 have stacked structure, the passages through which the coolant flows are communicated with one passage from the inlet port 431 to the outlet port 432. Therefore, the structure is simplified, and the management of the cooling temperature is facilitated.

(2) The first and second passages 151 and 251 and the first to third relay passages 252a to 252c were formed at the bottom sections 406a and 402a of the housings 406 and 402 and the sides of the housings 406 and 411. This makes is possible to reduce the number of additional members accompanying passage formation so that an inexpensive cooling structure can be obtained.

(3) In the structure in which the first to third space housings 411, 406 and 402 are stacked in three stages, the housing 406 as well as the housings 402 and 411 at the upper stage and the lower stage can be cooled by disposing the first and second passages 151 and 251 at the upper and lower sides of the housing 406 at the middle stage. Therefore, it is possible to simplify the cooling passage and shorten the length of the cooling passage. Moreover, as a result, it is possible to reduce the pressure loss in the cooling passage and improve the cooling efficiency.

Note that the input/output filter circuit sections 210 and 220 shown in Embodiments described above are merely examples, and other circuit configurations may be adopted. Moreover, the chopper of the high voltage circuit section 280 is exemplified as bidirectional, but may be a unidirectional chopper. Furthermore, the smoothing circuit of the DCDC converter circuit section 310 may have other circuit configurations or may be omitted as appropriate. The same applies to the other circuit sections, and the circuit configurations of the charger 10 and the DCDC converter circuit section 310 in Embodiments described above are merely examples. The present invention is not limited in any way by using other circuit configurations.

Similarly, various modification can be made for the shapes and structures of the first to third space housings 411, 406 and 402 or cooling structure. Moreover, Embodiments 1 to 7 described above can be combined.

Although various Embodiments and modifications have been described above, the present invention is not limited to these contents. Other aspects, which can be considered in a scope within the technical idea of the present invention, are also included within the scope of the present invention.

### REFERENCE SIGNS LIST

10 charger
100 DCDC converter integrated charger
101 first space
110 switching circuit section
150 first wall
151 first passage
201 second space
210 input filter circuit section
220 output filter circuit section
250 second wall
251 second passage
252a first relay passage
252b second relay passage
252c third relay passage
280 high voltage circuit section
301 third space
305 connection section
310 DCDC converter circuit section
406 second space housing
411 first space housing
421 input terminal
422 output terminal
471 first side (input terminal side)
472 second side (output terminal side)
500 control circuit section
S31, S32 switching element

1. A DCDC converter integrated charger, comprising:
an input filter circuit section (210) which removes input noise;
a switching circuit section (110) which converts AC power or first DC power inputted to the input filter circuit section into second DC power;
an output filter circuit section (220) which is connected to the switching circuit section and removes output noise;
a DCDC converter circuit section (310) which is connected to the switching circuit section and supplies power to a battery;
a first wall (150) which separates a first space (101), where the switching circuit section is disposed, and a second space (201), where the input filter circuit section and the output filter circuit section are disposed; and
a second wall (250) which separates a third space (301), which faces the first wall through the second space and where the DCDC converter circuit section is disposed, and the second space.

2. The DCDC converter integrated charger according to claim 1, further comprising:
a high voltage circuit section (280) which is electrically connected between the switching circuit section and the output filter circuit section and comprises switching elements (S31 and S32) for supplying power to a high voltage battery,
wherein the high voltage circuit section is disposed in the second space and comprises a connection section (305) to the DCDC converter circuit section.

3. The DCDC converter integrated charger according to claim 1, further comprising a control circuit section (500) which controls the switching circuit section or the DCDC converter circuit section 310,
wherein the control circuit section is disposed in the second space 201.

4. The DCDC converter integrated charger according to claim 3, wherein the control circuit section controls the switching circuit section and the DCDC converter circuit section.

5. The DCDC converter integrated charger according to claim 4, further comprising:
an input terminal (421) which is connected to the input filter circuit section and disposed in a second space housing (406) forming the second space; and
an output terminal (422) which is connected to the output filter circuit section and disposed in the second space housing.

6. The DCDC converter integrated charger 100 according to claim 5, wherein the second space housing comprises: an input terminal side (471) where the input terminal is disposed; and an output terminal side (472) where the output terminal is disposed, and
the input terminal side forms an angle (θ) different from the output terminal side.

7. The DCDC converter integrated charger according to claim 2, wherein the switching circuit section is disposed at the first wall near the first space,
the high voltage circuit section is disposed at the first wall near the second space, and
the DCDC converter circuit section is disposed at the second wall near the third space.

8. The DCDC converter integrated charger according to claim 7, wherein the first wall comprises a first passage (151),
the second wall comprises a second passage (251), and a relay passage (252) connecting the first passage and the second passage is formed
in a housing near the second space.
